(19) United States
(12) Patent Application Publication
(10) Pub. No.: US 2013/0152649 A1
(43) Pub. Date: Jun. 20, 2013

(54) IMMOBILIZATION OF FERTILIZER ADDITIVES

(71) Applicants: James A. Kweeder, Chesterfield, VA (US); Dean J. Collamer, Hanover, PA (US)

(72) Inventors: James A. Kweeder, Chesterfield, VA (US); Dean J. Collamer, Hanover, PA (US)

(73) Assignee: HONEYWELL INTERNATIONAL INC., Morristown, NJ (US)

(21) Appl. No.: 13/331,522

(22) Filed: Dec. 20, 2011

(51) Int. Cl. C05C 9/00; C05C 11/00; C05C 3/00; C05C 1/00; C05B 21/00; C05B 17/00

(52) U.S. Cl. 71/28; 71/64.07; 71/54; 71/32; 71/61; 71/27

(57) ABSTRACT

Fertilizer products, and methods of making fertilizer products are provided that include an additive, such as an agrochemical, coated onto a base fertilizer particle. The outer coating bonds to the inner coating and maintains the inner coating on the base fertilizer particle until the base fertilizer particle undergoes dissolution and releases the fertilizing component.

### FIELD OF THE INVENTION

The present technology relates to the immobilization of fertilizer additives, such as agrochemicals, that are coated onto fertilizer particles, and specifically to over-coatings that can be applied to fertilizer particles in order to maintain the fertilizer additives on the fertilizer particles.

### DESCRIPTION OF RELATED ART

Conventional fertilizers are granulated or compacted from mixtures of the constituent nutrients that are utilized to form the fertilizers. In some formulations, various additives, such as crop chemicals or “agrochemicals” are added to the mixtures in order to achieve additional goals in the plant products beyond fertilization. In many instances, the agrochemicals are added to the mixture of constituent nutrients and then granulated or compacted with the mixture to yield a finished product.

As new fertilizers are being processed by methods other than granulation, it has become more difficult to add additives such as agrochemicals to the fertilizers. Manufacturers have attempted processes by which fertilizer particles are coated with solutions that contain additives, but it has been found that many of the most desirable additives are not dissolvable in suitable solutions to coat the fertilizer particles.

It is common to apply liquid coatings to fertilizers to impart desirable properties or control undesirable properties. Dry additives, however, can only be used to the extent that they are soluble in the base liquid or to the extent that a useful liquid-solid suspension or slurry can be made and applied that provides an acceptable coating.

When additives are coated onto fertilizer particles using currently known methods, and the coated fertilizer is applied to soil, such as by spreading, the coating containing the additive is released from the fertilizer particle prior to the time that the base fertilizer, such as nitrogen, is released from the fertilizer particle. This results in the additive being released into the root zone at a first point in time after the coated fertilizer is applied, and allowing the additive time to leach out of the root zone prior to the time at which the base fertilizer enters the root zone. Such a sequential release pattern reduces the ability of the additive to interact with the base fertilizer, thus reducing the effectiveness of the additive.

Some fertilizer compositions are known that are time-release, or delayed release compositions. Such delayed release fertilizer compositions delay the amount of time that it would normally take for dissolution of the fertilizer particle to release the base fertilizer, such a nitrogen. However, even with such time-release formulations, additives applied in coatings on the fertilizer particle are released from the fertilizer particle prior to the time that the base fertilizer is released from the fertilizer particle.

### SUMMARY OF THE INVENTION

The present technology relates to fertilizer products, and methods of making fertilizer products, that include an outer coating that inhibits the release of additives coated onto a fertilizer particles.

In one aspect, a method of making a fertilizer product is provided that includes steps of: providing a base fertilizer particle comprising at least one fertilizing component, applying an inner coating to the fertilizer particle to form a fertilizer-additive particle, and applying a water insoluble outer coating to the fertilizer-additive particle to form the fertilizer product. The inner coating can include at least a first layer, wherein the first layer comprises at least one additive, such as an agrochemical. The outer coating bonds to the inner coating and maintains the inner coating on the base fertilizer particle until the base fertilizer particle undergoes dissolution and releases the fertilizing component.

In another aspect, a second method of making a fertilizer product is provided that includes steps of: providing a base fertilizer particle comprising at least one fertilizing component, applying an inner coating to the fertilizer particle to form a fertilizer-additive particle, and applying a water insoluble outer coating to the fertilizer-additive particle to form the fertilizer product. The inner coating can include a first layer and a second layer, wherein the first layer can include at least one additive, and the second layer can be a sealing layer. The outer coating bonds to the inner coating and maintains the inner coating on the base fertilizer particle until the base fertilizer particle undergoes dissolution and releases the fertilizing component.

### BRIEF DESCRIPTION OF THE DRAWINGS

Specific examples have been chosen for purposes of illustration and description, and are shown in the accompanying drawings, forming a part of the specification.

FIG. 1 illustrates a cross-section of one example of a fertilizer particle of the present technology.

FIG. 2 illustrates a cross-section of a second example of a fertilizer particle of the present technology.

### DETAILED DESCRIPTION

Fertilizer products, and methods of making fertilizer products, of the present technology include an outer coating to immobilize additives applied as coatings to fertilizer particles, preventing the additives from being released separately from the dissolution of the base fertilizer particle that releases a fertilizing component. When additives are coated onto fertilizer particles using the present technology, and the coated fertilizer is applied to soil, such as by spreading, the coating containing the additive is maintained with the base fertilizer particle.

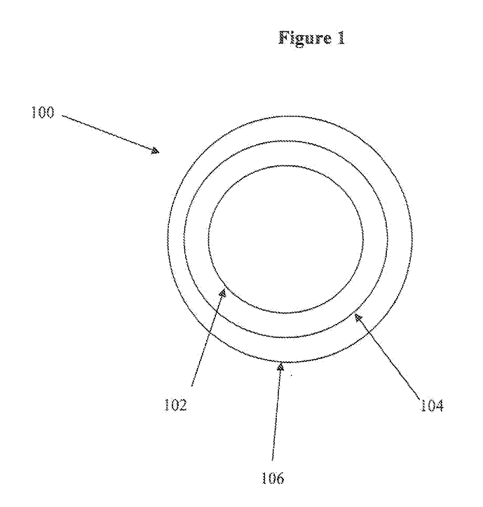

FIG. 1 illustrates one example of a fertilizer particle of the present technology. While FIG. 1 illustrates the fertilizer product as having a circular cross section, it should be understood that fertilizer particles of the present technology can have any shape. The fertilizer product 100 as illustrated in FIG. 1 includes a base fertilizer particle 102, an inner coating 104, and an outer coating 106.

The base fertilizer particle 102 can be any suitable fertilizer particle formed by any suitable process. The base fertilizer particle 102 can comprise any suitable fertilizing component that can be produced or sold in bulk and can additionally be coated with another material. The base fertilizer particle 102 can comprise, for example, one or more fertilizing components including nitrogen, phosphorous, potassium, potash, urea, ammonium salts including ammonium sulfate, ammonium nitrate, ammonium sulfate nitrate, and combinations thereof. The base fertilizer particle 102 can be formed by processes including but not limited to crystallization, granulation, and prillling.

Once the base fertilizer particle has been provided, the inner coating can be applied to the base fertilizer particle to form a fertilizer-additive particle. The inner coating 104 can include at least one layer that contains at least one additive, such as an agrochemical. Any additive used may or may not be dissolvable in a liquid solvent, such as water. When the additive is a liquid, or is dissolvable in a liquid, the layer of the inner coating 104 that comprises the additive can be applied as a liquid to the base fertilizer particle 102. When the additive is a solid, various methods can be used for forming and applying the layer of the inner coating 104 that comprises the additive. For example, some solid additives can be applied by mixing them with a binding agent and then applying the mixture as a coating to the base fertilizer particle 102. However, in such examples, the amount of solid additive may be limited in order to provide a coating that will flow and spread in a suitable manner. In other examples, a solid additive can be mixed with a flow agent, or surface agent, to yield a solid mixture dispersant that is similar to a liquid mixture in that it will flow, spread, coat, and then stick to the surface of the base fertilizer particle 102 to form the fertilizer-additive particle. The flow agent can be, for example, a powder that results in a mixture with suitable properties to disperse and spread the additive onto the surface of the at least one fertilizer granule. In such examples, the fertilizer-additive particle can then be coated with a sealing layer to seal the layer comprising the additive in place. Some such examples are described in U.S. Pat. No. 7,785,387 to James A. Kweeder, the disclosure of which is incorporated by reference herein in its entirety.

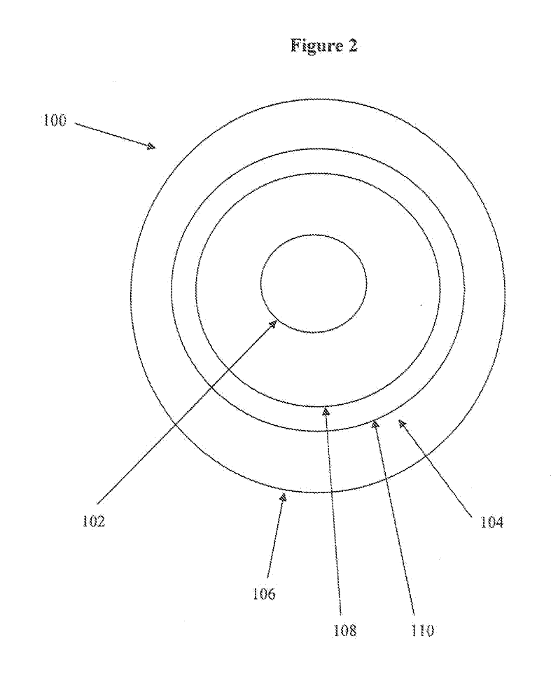

In examples where the inner coating 104 includes an additive layer and a sealing layer, such as the example illustrated in FIG. 2, the first layer 108 of the inner coating 104 can be formed by providing a base fertilizer particle 102, providing a dispersant that includes at least one additive mixed, or blended, with at least one flow agent, which can be in a powder form, and applying the dispersant as the first layer 108 to the base fertilizer particle 102 to form a base fertilizer-additive particle. The second layer 110 of the inner coating 104 can be formed by providing a fertilizer-dispersant particle, providing a sealing layer, and applying the sealing layer to the fertilizer-dispersant particle.

In one example where the additive is a nitrification inhibitor, such as dicyanodiamide (DCD), the base fertilizer particle 102 can comprise ammonium sulfate, and the flow agent can be an amorphous sodium aluminum silicate powder, such as Zeolex™ 80, sold by J. M. Huber of Maryland. The amount of the amorphous sodium aluminum silicate powder can be, for example, about 10% by weight of the mixture of DCD and amorphous sodium aluminum silicate powder.

In another example, where the base fertilizer particle 102 comprises the fertilizing component urea, the additive can be an urease inhibitor.

The sealing layer 110 of an inner coating 104 can be selected to at least seal or hold the dispersant into place on the fertilizer granule. Sealing layer materials may also be designed to impart other properties to the final fertilizer granule, such as smoothness or roughness, color coding for blending with other fertilizer granules, time-lapse introduction to the fertilizer target, increased solvation with water after application to the fertilizer target, etc. Sealing layer materials can include, for example, standard wax-type dedust/anti-cake materials, which are designed to seal the dispersant material into place on the base fertilizer particle 102.

Although some of the contemplated materials can be in powder or wax form, it is contemplated that the materials disclosed herein may be dissolved in at least one solvent in order to formulate the particular compound, prepare the compound for the application, or impart additional chemical properties to the compound. For example, a solvent or solvents may be utilized to impart a rougher or porous surface to the base fertilizer particle 102, in order to naturally hold more of the applied additives. Contemplated solvents include any suitable pure or mixture of organic molecules that are volatilized at a desired temperature, such as the critical temperature, or that can facilitate any of the above-mentioned design goals or needs. The solvent may also comprise any suitable pure or mixture of polar and non-polar compounds. As used herein, the term “pure” means that component that has a constant composition. For example, pure water is composed solely of H₂O. As used herein, the term “mixture” means that component that is not pure, including salt water. As used herein, the term “polar” means that characteristic of a molecule or compound that creates an unequal charge, partial charge or spontaneous charge distribution at one point of or along the molecule or compound. As used herein, the term “non-polar” means that characteristic of a molecule or compound that creates an equal charge, partial charge or spontaneous charge distribution at one point of or along the molecule or compound.

In some contemplated embodiments, the solvent or solvent mixture (comprising at least two solvents) can comprise those solvents that are considered part of the hydrocarbon family of solvents. Hydrocarbon solvents are those solvents that comprise carbon and hydrogen. It should be understood that a majority of hydrocarbon solvents are non-polar; however, there are a few hydrocarbon solvents that could be considered polar. Hydrocarbon solvents are generally broken down into three classes: aliphatic, cyclic and aromatic. Aliphatic hydrocarbon solvents may comprise both straight-chain compounds and compounds that are branched and possibly crosslinked, however, aliphatic hydrocarbon solvents are not considered cyclic. Cyclic hydrocarbon solvents are those solvents that comprise at least three carbon atoms oriented in a ring structure with properties similar to aliphatic hydrocarbon solvents. Aromatic hydrocarbon solvents are those solvents that comprise generally three or more unsaturated bonds with a single ring or multiple rings attached by a common bond and/or multiple rings fused together. Some hydrocarbon solvents include, for example, toluene, xylene, p-xylene, m-xylene, mesitylene, solvent naphtha H, solvent naphtha A. alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers halogenated hydrocarbons, such as chlorinated hydrocarbons, nitrated hydrocarbons, benzene. 1,2-dimethylbenzene, 2,4-trimethylbenzene, mineral spirits, kerosine, isobutylbenzene, methylnaphthalenes, ethyltoluene, ligroine. Particularly contemplated solvents include, but are not limited to, pentane, hexane, heptane, cyclohexane, benzene, toluene, xylene and mixtures or combinations thereof.

In some alternative examples, the solvent or solvent mixture may comprise those solvents that are not considered part of the hydrocarbon solvent family of compounds, such as ketones, such as acetone, diethyl ketone, methyl ethyl ketone and the like, alcohols, esters, ethers and amines. In yet other examples, the solvent or solvent mixture may comprise a combination of any of the solvents mentioned herein.

The outer coating 106 can be selected to bond with the inner coating 104 and maintain the additive of the inner coating 104 in the root zone of a plant with the base fertilizer particle 102. The outer coating 106 is preferably selected to maintain the additive with the base fertilizer particle 102 while not inhibiting the intended dissolution of the base fertilizer particle 102. In one example where the base fertilizer particle 102 contains nitrogen, once the base fertilizer particle 102 is applied to soil, it undergoes a dissolution conversion process to form NH₃ and NO₃⁻¹ by normal biological processes. In such an example, the additive can be a nitrification inhibitor, such as DCD. Under standard conditions, the DCD coated onto a base fertilizer particle 102 can be washed off the base fertilizer particle 102 in the root zone by water in the soil and carried away, thereby rendering the DCD ineffective. In examples of the present technology, the outer coating 106 water insoluble, and bonds with the inner coating 104.

The outer coating 106 maintains the inner coating on the base fertilizer particle until the base fertilizer particle undergoes dissolution and releases the fertilizing component. Because the inner coating remains on the base fertilizer particle until the base fertilizer particle starts to break up due to dissolution, the additive contained therein is released to the soil, and is present in the soil root zone, concurrently with the fertilizing component released from the base fertilizer particle 102.

The outer coating 106 can be selected from waxes, oil based coatings, and other suitable water insoluble coating materials.

### EXAMPLE

A DCD/Zeolex mixture was prepared that comprised 90 weight percent DCD and 10 weight percent of Zeolex 80. The dry mixture was then applied to about 50 pounds of ammonium sulfate in a drum blender. The mixture was allowed to spread and adhere to the surface. A molten wax/oil based dedusting agent (as typically used on fertilizers and readily available from suppliers like ArrMaz Custom Chemicals) was then applied to the surface-coated fertilizer and allowed to spread and solidify on to the coated ammonium sulfate. A set of similar mixtures were prepared according to Table 1.

TABLE 1

| | Ammonium | | | NuFarm ATH |
|---|---|---|---|---|
| DCD Nitrogen | Sulfate | DCD | Zeolux 80 | 610 + 3676 |
| 5% DCDN | 50 lb | 381 g | 42.3 g | 225 g |
| 7% DCDN | 50 lb | 544 g | 60.4 g | 225 g |
| 10% DCDN | 50 lb | 803 g | 89.2 g | 225 g |

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A method of making a fertilizer product, the method comprising steps of:
providing a base fertilizer particle comprising at least one fertilizing component;
applying an inner coating to the fertilizer particle to form a fertilizer-additive particle, the inner coating comprising at least a first layer, wherein the first layer comprises at least one additive;
applying a water insoluble outer coating to the fertilizer-additive particle to form the fertilizer product, wherein the outer coating bonds to the inner coating and maintains the inner coating on the base fertilizer particle until the base fertilizer particle undergoes dissolution and releases the fertilizing component.

2. The method of claim 1, wherein the at least one fertilizing component of the base fertilizer particle is selected from the group consisting of nitrogen, phosphorous, potassium, potash, urea, ammonium salts including ammonium sulfate, ammonium nitrate, ammonium sulfate nitrate, and combinations thereof.

3. The method of claim 1, wherein the base fertilizer particle is formed by processes selected from the group consisting of crystallization, granulation, and prillling.

4. The method of claim 1, wherein the first layer is applied to the base fertilizer particle as a liquid.

5. The method of claim 1, wherein the additive is a solid, and the first layer further comprises a binding agent.

6. The method of claim 1, wherein the additive is a solid, and the first layer further comprises a flow agent.

7. The method of claim 6, wherein the flow agent comprises amorphous sodium aluminum silicate.

8. The method of claim 1, wherein the inner coating further comprises a second layer that is a sealing layer.

9. The method of claim 8, wherein the sealing layer comprises a wax-type dedust/anti-cake material.

10. The method of claim 1, wherein the at least one fertilizing component comprises urea, and the additive comprises an urease inhibitor.

11. The method of claim 1, wherein the at least one fertilizing component comprises ammonium sulfate, and the additive comprises dicyanodiamide.

12. The method of claim 1, wherein the outer coating is a wax.

13. The method of claim 1, wherein the outer coating is an oil based coating.

14. A method of making a fertilizer product, the method comprising steps of:
providing a base fertilizer particle comprising at least one fertilizing component;
applying an inner coating to the fertilizer particle to form a fertilizer-additive particle, the inner coating comprising a first layer and a second layer, wherein the first layer comprises at least one additive, and the second layer is a sealing layer;
applying a water insoluble outer coating to the fertilizer-additive particle to form the fertilizer product, wherein the outer coating bonds to the inner coating and maintains the inner coating on the base fertilizer particle until the base fertilizer particle undergoes dissolution and releases the fertilizing component.

15. The method of claim 12, wherein the at least one fertilizing component of the base fertilizer particle is selected from the group consisting of nitrogen, phosphorous, potassium, potash, urea, ammonium salts including ammonium sulfate, ammonium nitrate, ammonium sulfate nitrate, and combinations thereof.

16. The method of claim 12, wherein the additive is a solid, and the first layer further comprises a flow agent.

17. The method of claim 16, wherein the flow agent comprises amorphous sodium aluminum silicate.

18. The method of claim 17, wherein the at least one fertilizing component comprises ammonium sulfate, and the additive comprises dicyanodiamide.

19. The method of claim 12, wherein the outer coating is a wax.

20. The method of claim 12, wherein the outer coating is an oil based coating.
